(19) United States
(12) Patent Application Publication
(10) Pub. No.: US 2005/0031499 A1
(43) Pub. Date: Feb. 10, 2005

(54) Ultrasound device

(76) Inventor: Beatrix Christa Meier, Entrischenbrunn (DE)

Correspondence Address: David E Huang, 1700 West Park Drive, Westborough, MA, 01581, US

(21) Appl. No.: 10/491,763

(22) PCT Filed: Sep. 27, 2002
(86) PCT No.: PCT/DE02/03670

(30) Foreign Application Priority Data
Oct. 4, 2001 (DE) 101-48-916.1

(51) Int. Cl. B02C 11/00

(52) U.S. Cl. 422/128; 435/259; 366/127; 241/2

(57) ABSTRACT

The invention relates to an ultrasound device comprising a piezo element (4), which generates ultrasound waves, and intermediate elements (5, 6) via which the ultrasound waves are transmitted to the probes (7) and into a sample volume inside a microplate (1). A piezo element (4) comprises a number of probes (7), which radiate the ultrasound and which are arranged next to one another in a row. Between the point of origin of the sound wave on the piezo element (4) and the point of output of the sound wave on the radiating probes (7), the wave-transmitting elements (5, 16) do not widen at all with regard to the surface of the piezo element (4).

The invention relates to an ultrasound device, specially an ultrasound device for the disintegration of cells or cellular material.

In the context of biological and pharmaceutical testing tendency goes to small sample quantities, worked on automatically with high throughput in standard microplates, also called multi-well-plates. These microplates exhibit sample containers, called wells, in a number of between 6 (2×3) and 9600 (80×120) with volumes of millilitres down to picolitres. The plates possess a fixed outer size of approximately 85×128 mm with a precise arrangement of the sample containers (wells). External size and the arrangement of the wells usually follow the international ANSI standard.

In order to examine biological cell material the cells have to be disintegrated, which means that the cell walls must be opened or destroyed, in order to get to the material located inside of the cell. This cell disintegration has to be performed as carefully as possible and in a way, that the addition of foreign substances to the sample can be avoided.

With ultrasonic it is possible to disintegrate cells in small volumes, below one millilitre, rapid and without the addition of foreign material. The cells suspended in a liquid medium are destroyed by ultrasonic waves of low frequency and high power.

High frequent acoustic waves with high amplitude cause the formation of small bubbles in liquids, which first increase, until they implode. This effect, called cavitation, leads to the disintegration of membranes and cell walls by the arising fast changes in pressure. The cavitation is stronger in the range of low frequencies than in the range of high frequencies, so that for the disintegration of cells ultrasonic waves with frequencies as low as possible should be used.

Usually the applied ultrasonic frequencies are about 20 kHz, since the range is limited downwards by the threshold of audibility.

An ultrasonic device for such an application consists of a generator, which produces an electrical output wave (sinus wave) with a frequency of for example 20 kHz, an ultrasonic electrical transducer, which is usually of the piezoelectric type, and converts the electrical output wave from the generator into a mechanical motion perpendicular to the surface of the ultrasonic electrical transducer, a mechanical transducer (impedance transducer), which forwards the ultrasonic energy generated at the electrical ultrasonic transducer, as well as an ultrasonic horn and/or a probe, which focuses the ultrasonic power and directs it into the liquid with the sample.

The oscillating probe causes extremely high acoustic pressure fluctuations in the liquid at its tip, which are responsible for the phenomenon of cavitation.

Horn and probes serve, as mentioned, for the transmission of ultrasonic into the sample. They cause thereby, dependent on their geometries, an increase of the intensity: The intensity of ultrasonic irradiation into the medium increases upon decreasing the final diameter at the end point of the tip. However, it is not possible to transmit any desired level of amplitude simultaneously with high acoustic power into the medium. Moreover, the size of the tip has to be adapted to the size of the sample tube. For this reason the probes and tips have to decrease in diameter towards the end, if they are operated in the small volumes of a microplate.

The geometry at the end of the tip also determines the radiation behavior. An even surface of the tip perpendicularly to the longitudinal direction causes a strong radiation in forward direction; a conical tip causes a stronger lateral radiation.

From the U.S. Pat. No. 6,071,480 an ultrasonic device is known, in which micro vessels are arranged in the maximal amplitude of the transversal wave, which has for instance the double frequency of the longitudinal wave. In the end plate of such an ultrasonic horn are holes for the micro vessels, into which the micro vessels are inserted. This arrangement has the disadvantage that it cannot be used for standardized sample container arrangements, because the amplitude maximums on the surface of the end plate possess geometrical figures in the kind of circles and not in a the rectangular pattern of the microplates mentioned. For this reason the ultrasonic device known from U.S. Pat. No. 6,071,480 can be only used in connection with the described, separate micro sample containers.

So far samples are disintegrated in microplates with ultrasonic by dipping the tip of a probe manually into each particular well. This technique of disintegration is time consuming and cannot be standardized.

The used of multi-element-probes has previously been tried. To an impedance transducer, in the form of a relatively broad block several tips are arranged side by side in a row. To this the electric transducer, e.g. a piezo element, is connected via a relatively narrow coupling transducer. By this arrangement the problem arises, that already with few tips the distribution of ultrasonic intensity is uneven.

In U.S. Pat. No. 4,571,087 a device for the positioning of each individual well of a microplate above an ultrasonic horn is described. From the ultrasonic probe, located perpendicularly under the well of a microplate, the ultrasonic power is transferred into the well via a liquid bath, usually a water bath, while the microplate is moved by the device in x-y-direction. This device has the disadvantage, that the individual wells of the microplate can only be treated separately one after another with ultrasonic, which is time consuming and an high energy transfer into the samples is not possible.

Purpose of the invention is it to create an ultrasonic device for the acoustic irradiation of media in microplates, or similar arrangement of tubes, or also in chips, with which an even acoustic irradiation of a whole set of containers etc. is possible.

This task is solved according to the invention with the ultrasonic device indicated in the patent claim 1. Favorable arrangements are described in the sub-claims.

In the ultrasonic device according to the invention therefore, no widening of the wave transmitting elements occurs between the origin of the sound pressure wave at the ultrasonic electric transducer, and the emitting place of the sound pressure wave at the ultrasonic emitter. It showed up, that a widening causes a disturbance in the wave propagation, which leads to an uneven amplitude distribution.

Finally, all elements by which the sound moves, are essentially located within the active surface of the ultrasonic electrical transducer.

The invention is particularly favorably applicable with ultrasonic devices, with which several sound-delivering elements are arranged in a row and/or a surface next to each other.

Instead of a linear arrangement also a two-dimensional arrangement is possible. So the arrangement can be square for example. Also transitions to round or rectangular arrangements are possible. Important is above all, that within the entire arrangement no transverse forces or transverse vibrations, i.e. no transverse-waves or no bending-vibrations are developed. Thus the surface has to be excited into a relatively even, longitudinal oscillation.

The same applies not only to the sound-emitting elements, but also to the sound-generating ultrasonic electrical transducer which can likewise be arranged in a majority, and/or in different linear and/or in two-dimensional ways.

With the ultrasonic device according to the invention both, a direct acoustic irradiation of a microplate located below the sound-emitting element or an indirect acoustic irradiation of a microplate, which lies above the sound-emitting element, are possible. The plate can be cooled during the direct acoustic irradiation.

On the market so far no ultrasonic device is available, which would be suitable for a fast and reproducible disintegration of cells in microplates. The ultrasonic device according to the invention solves this problem. It is possible thereby to achieve a rapid, reproducible disintegration directly in the microplate, which is necessary for the standardization and certifying of tests. The ultrasonic device according to the invention offers all possibilities for automation and can, in combination with other devices, be used in high throughput processes.

The ultrasonic device according to the invention for sonic irradiation of microplates can find applications within several domains of pharmacy, biotechnology, diagnostics, environmental technology, microbiology, immunology, cell biology and medicine. Examples for applications cover apart from the disintegration of biological material, e.g. tissues, cells, bacteria, cell material, organelles, aggregates, viruses, high-throughput-screening, toxicity studies for sample preparation in enzymatic tests, ELISA's, RIA's, genomics and proteomics, PCR and/or RT-PCR, DNA- or RNA-labeling, hybridizing, receptor-binding-studies for acceleration, catalysis and increase of the yield of chemical reactions, production of liposomes, micro-emulsions, nano-particles and suchlike as well as for suspending, homogenizing, emulsifying and extracting and others.

On the basis of the drawings the invention is described exemplarily. They show:

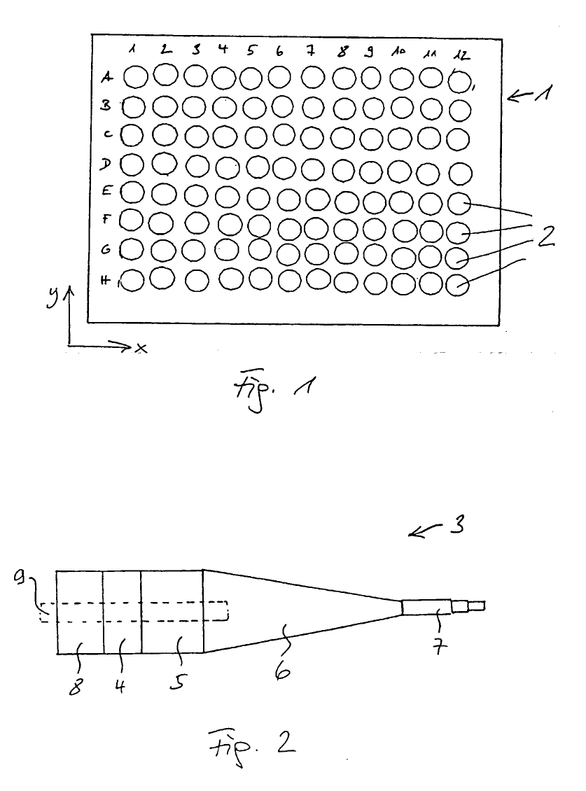

FIG. 1 a standardized micro plate;

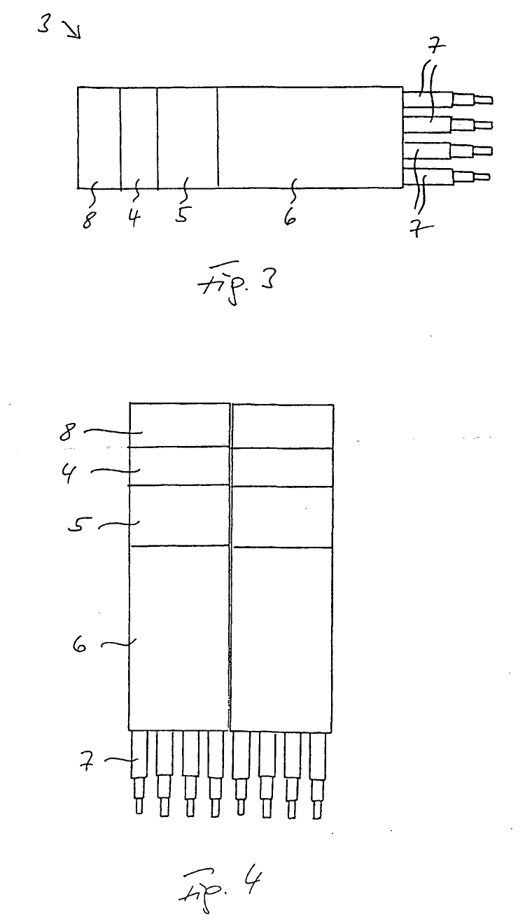

FIG. 2 an ultrasonic horn for the microplate of FIG. 1 in a view parallel to the longitudinal axis of the ultrasonic horn;

FIG. 3 the ultrasonic horn of the FIG. 2 in a view transverse to the longitudinal axis;

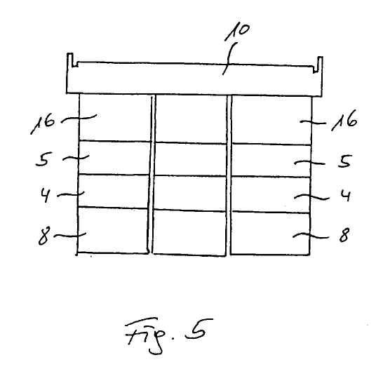

FIG. 4 a view similarly to FIG. 3, whereby two ultrasonic horns are arranged in longitudinal direction next to each other; and

FIG. 5 a device for the indirect irradiation of the microplate of FIG. 1 in a side view.

In FIG. 1 a microplate according to ANSI standard is shown. In these standardized microplates (1) with the external dimensions of 85 mm×127.76 mm are the wells (2) for the samples, arranged in such a manner, that the number of wells in horizontal direction (in x-direction) is an integral multiple of three and in vertical direction (in y-direction) an integral multiple of two. The presently mostly used 96-well-microplate, shown in FIG. 1 exhibits 12 wells in horizontal direction 8 and in vertical direction. The inside diameter of the wells (2) is in each case 6 mm in a 96-well-platte.

An ultrasonic horn for the direct acoustic irradiation of a number of wells (2) of a 96-well-mikroplatte (1) can contain 4 probes next to one another, for example. With two of those ultrasonic horns, which are arranged in longitudinal direction next to each other, it is possible to irradiate a complete row of wells (2) of the microplate (1) in y-direction.

FIG. 2 shows an ultrasonic probe (3) for the microplate (1) in a view parallel to the longitudinal axis of the ultrasonic horn, i.e. the drawing plane is perpendicularly to the longitudinal axis. FIG. 3 shows an ultrasonic horn (3) with the axis rotated by 90°. As shown in FIGS. 2 and 3, the ultrasonic horn (3) is constructed as follows:

A piezo element (4) forms the core of the ultrasonic horn (3). The piezo element (4) converts the electrical waves or impulses from a generator (not shown) into mechanical impulses (acoustic waves, ultrasonic waves). To the piezo element (4) in the irradiation direction an impedance transducer (5) is connected, which has a length of a quarter wave. To the impedance transducer (5) an ultrasonic horn (6) is connected, which in one dimension linear tapered in a conical way and causes a first focusing of the ultrasonic power on a rectangular area. The ultrasonic horn (6) is three-quarter of the wave long. The narrow end of the ultrasonic horn (6) is connected to ultrasonic probes (7), each possessing at the end a quartz tip (not shown) fixed with glue.

Form and structure of the ultrasonic horn (6) and the probe (7) are arranged in such a way, that a standing wave is formed. At end face of the tip of the probe (7) the ultrasonic power should be emitted as homogeneously as possible. This is ensured best by a rod with an even end face, which is evenly brought to oscillations over its whole width, in order to avoid bending-vibrations. In addition the probes are equipped with replaceable quartz tips. During the transition to the quartz the stage reduction should be as small as possible, in order to avoid breaking of the quartz.

Usually aluminum and quartz are the preferential materials for the sound-transmitting parts of the ultrasonic head (3), however obviously also other materials are general usable, as long as they possess comparable impedance factors.

The piezo element (4) generates ultrasonic waves with a frequency of typically 20 kHz and with energy sufficient for cavitation in the wells (2) of the microplate (1) and which is also sufficient to disintegrate cells or cellular material.

An end piece (8), which is arranged behind the piezo element (4), makes a tightening of the piezo elements (4) between the end piece (8) and the ultrasonic horn (6) possible by means of a screw (9). The screw runs through the end piece (8), the piezo element (4) and the impedance transducer (5) and is screwed into the ultrasonic horn (6).

The end piece (8), the piezo element (4), and the impedance transducer (5) are cylindrical and possess all the same diameters. This diameter is 35 mm, for example, for the ultrasonic head (3) used in a standard 96-well-microplates (1).

Alternatively, the end piece (8), the piezo element (4), and the impedance transducer (5) can possess also other forms, e.g. they can be square or rectangular in its cross section.

To form the ultrasonic horn (6) either a round or a square column can be used. The side of the square has to be similar to the diameter of the end piece (8), the piezo element (4) and the impedance transducer (5). Alternatively, a cylinder with the same diameter as these parts, e.g. 35 mm, can be used.

In the dimension transverse to the longitudinal direction the ultrasonic horn (6) tapers itself, as shown in FIG. 2, from the full edge length and/or the full diameter to a width, which is about the width, respectvely the diameter of a probe (7) or it is slightly larger.

In the example described, the ultrasonic horn (6) tapers itself to an area of 35 mm×9 mm.

FIG. 3 shows a front view on the ultrasonic horn (3). It is shown that in the longitudinal direction along the centre line of the ultrasonic horn (6), four probes (7) are inserted into the ultrasonic horn (6). The distance of the tips of the probes (7) corresponds exactly to the distance of the wells (2) in the microplate (1).

Impedance transducer (5), the ultrasonic horn (6) and the part of the probe (7), into which the quartz tip is inserted, consist preferably of aluminum or an aluminum alloy, which exhibits good sound transmission characteristics. The end piece (8) consists preferably of brass and alternatively of steel or tantalum.

The quartz tips of the probes (7) can possess a diameter of 2 mm for the use in microplates with up to 384 wells. Using microplates with a higher amount of wells the diameter has to be reduced according to the size of the wells. The form of the tip can be linear as a rod or conically tapering, particularly for higher energy entries.

As shown in FIG. 4, two of such ultrasonic heads (3) can be arranged in longitudinal direction next to each other, whereby the arrangement takes place in a manner that the distance between all probes (7) is the same and corresponds to the distance of the wells (2) in the microplate (1). With such an arrangement a complete row of wells (2) can be treated at the same time.

Alternatively, also a common ultrasonic horn (6) can be used for two pairs of piezo elements, two end pieces, two impedance transducers (exciter arrangements) (4, 5, 8) and eight probes (7), in the example described. In this case the ultrasonic horn (6) consists of a plate with oblong-rectangular basic form, and their length is essentially equal to the overall length of the exciter arrangements next to one another (4, 5, 8). The thickness of the horn is equal to the exciter arrangements (4, 5, 8) and is tapering towards the probes (7) according to the illustration in FIG. 2. With such an ultrasonic head the exciter arrangements (4, 5, 8), and the probes (7) are in each case arranged along the centre line of the elongated ultrasonic horn (6).

Such ultrasonic heads can also be arranged next to each other in such a way that a two-dimensional array of probes is formed, with which a whole microplate can be treated at one time. Alternatively, it is possible, for example, to treat each second row of wells (2) in the microplate (1). Naturally also arrays for the treatment of half etc. microplate can be manufactured.

The number of exciter arrangements (4, 5, 8) and the number of probes (7) at a common ultrasonic horn (6) is arbitrary in each case and can be selected with consideration of the intended application. Equally, as many ultrasonic horns (6) as desired can be arranged next to each other or can be interconnected, in order to form linear and/or two-dimensional arrays.

Also with two-dimensional array arrangements a common ultrasonic horn (6) can be planned, with all exciter arrangements (4, 5, 8), and probes (7), whereby the exciter arrangements (4, 5, 8) and the probe (7) form a rectangular arrangement in each case.

The focusing of the ultrasonic power within the range of the ultrasonic horn (6) can be achieved by different geometrical arrangements of the horn (6). Possible is once a stacked form, by which the cross section of the horn (6) decreases by steps. Moreover, an exponential form is possible, in which the cross section of the horn (6) decreases continuously in an exponentially way. Finally a conical form is possible, in which the cross section over the length decreases in a linear way. This type is very stable and simple to manufacture and is therefore preferred, although the focusing effect is smaller than with the other two arrangements.

Essential is in all arrangements, that between the origin of the acoustic wave at the respective piezo element (4) up to the tip of the associated probe (7) essentially no widening of the wave-transferring parts arises, even if it is reduced again. In no position, perpendicularly to the sound propagation, the sound-transferring parts should possess a cross-section area, which is substantially larger than the surface of the piezo elements (4) and/or the ultrasonic transducer. If necessary, a widening of 20 to 30% is permissible at the transition to the piezo element (4). Possible are also small recessing in the sound transmitting parts for example for the attachment of fixtures. Of course one has to take care that the fixing points are always at the nodes of the wave and not at the antinodes.

It is also important, that the tips of the probes are centrically arranged, that means in the case of a linear arrangement on the centre line of the ultrasonic horn (6), of the impedance transducer (5) and the piezo elements (4).

The arrangement described can be supplemented by mechanisms for automatic moving and shifting of the ultrasonic head (3) and/or the microplate (1) in the three directions in space.

Alternatively to the arrangement described for the direct ultrasonic radiation of the samples in microplates by immersing the tips into the sample liquid from above also an arrangement for indirect radiation through the bottom of the microplate can be planned. A part of the ultrasonic power is absorbed by the bottom of the microplate. However the movement of the ultrasonic tips towards the sample and the cleaning of the ultrasonic tips after each treatment are not necessary in this arrangement.

An even indirect irradiation of the entire microplate is only possible by excitatation with a number of piezo elements vibrating in phase. In the ideal case this is performed by a number of independently vibrating transducers whose number corresponds to the number of wells exposed to sound. The limit, up to which this is possible in practice, is reached with a 96-well-plate.

A more general construction, which can be used for all microplates, consists of a metal plate on which the microplate is put. The metal plate is brought to evenly vibration over the whole area by a number of piezo elements located below the plate, covering its whole lower area.

The structure of such an arrangement, representing a second form of the ultrasonic device, is shown in FIG. 5. In principle this structure corresponds to an arrangement according to FIGS. 2 and 3 turned upside down, with a distribution of the piezo element (4) over the whole area. The probe (7) is replaced by a metal plate (10) and the ultrasonic horn is replaced by a transmission cylinder (16).

In detail, the arrangement shown in FIG. 5 consists of the end piece (8), the piezo element (4), and the impedance transducer (5). The end piece (8), the piezo element (4) and the impedance transducer (5) are screwed onto the solid transmission cylinder (16). At the other end of the transmission cylinder (16) the metal plate (10) is fastened. The metal plate (10) is covered with a number of excitation and transmission arrangements (4, 5, 8, 16), in such a way, that only little gaps remain between each individual excitation and transmission arrangement (4, 5, 8, 16). In other words, the metal plate (10) is closely occupies with excitation - and transmission arrangements (4, 5, 8, 16).

The diameter of the transmission cylinder (16) corresponds in each case to the diameter of the piezo element (4). However, it not tapers itself, as this is the case with the ultrasonic horn (6) of the first type. Again is important, that no broadenings occur in the direction of the acoustic waves between the piezo element (4), the beginning of the transmission cylinder (16) and the metal plate (10). It is guaranteed, that no substantially broadening of the sound transmission occur, also at the transition of intermediate cylinder (16) to the metal plate (10), by close covering the metal plate (10) with the excitation and intermediate elements (4, 5, 8, 16).

The whole arrangement is so dimensioned, that the end plate, from which the ultrasonic wave is emitted into a liquid or to the bottom of the microplate, is located at the amplitude maximum, i.e. at an integral multiples of the lambda/2 wave. Attachment- and transition points should lie in the nodes of the sonic wave.

The piezo elements (4) must vibrate with the same energy in phase, in order to irradiate all samples in the wells (2) of the microplate (1) with the same ultrasonic power.

The microplate can be directly put on the surface of the metal plate (10) or into a bath inside the metal plate (10). The external dimensions of the metal plate (10) correspond to the external dimensions of the microplate (1) plus an edge. A liquid bath is necessary to radiate ultrasonic energy into wells in U- or V-form. If the bottom of the microplate is planar it can be put on the metal plate (10) without adding a liquid. Without liquid the sound transmission can be improved by a Mylar foil (Mylar is a registered trade mark of the DuPont group for a polyester foil) or a liquid film with high viscosity.

To avoid splashes, the microplate can be covered with a foil. During the direct acoustic irradiation this foil can be simply punctured by the tips. Thus each wells of the microplate is covered, and the neighboring wells cannot be contaminated during the treatment with ultrasound.

Preferably, the ultrasonic power irradiated into the sample volume is measured and the measurement result is used for the regulation of the energy emission. Thus it is also possible to irradiate with a slightly higher energy at the beginning of the treatment with ultrasound and down-regulate afterwards in such a way, that the energy level emitted into the sample volume remains constant. Favorably a sensor, p. e. a further ultrasonic electric transducer is attached at the sample, for instance in form of a piezo element, which measures the acoustic pressure irradiated into the sample volume as an electrical signal. By a sensor attached directly to the sample and/or the microplate it is possible to measure the amplitude of the irradiated ultrasonic wave directly at the sample and keep it constant by an appropriate regulation.

Measurement and regulation of the irradiated amplitude or energy is also possible by measuring the pressure, the force, or simply by an increase of weight at the sample/s volume. In case of a direct radiation the microplate can be simply put on a balance.

1. Ultrasonic device marked by an ultrasonic electrical transducer (4), which generates ultrasonic waves, which are transferred via intermediate elements (6, 16) into a sample volume (2), wherein an even longitudinal oscillation develops over several ultrasonic radiating elements (7) or a surface (10) and thus causing an even irradiation of ultrasonic into several sample containers simultaneously, caused by an arrangement, that from the generating place of the acoustic wave at the ultrasonic electrical transducer (4) via the wave-transmitting intermediate elements (6, 16) up the radiating element (7, 10) emitting the acoustic wave to the sample, at essentially no widening arises in relation to the generating place of the acoustic wave.

2. Ultrasonic transducer defined in claim 1, wherein for each ultrasonic transducer (4) several ultrasonic radiating elements (7) are available.

3. Ultrasonic device defined in claim 1, wherein for one ultrasonic radiating elements (10) several ultrasonic electric transducers (4) without or with intermediate elements (5, 16) are available.

4. Ultrasonic device defined in claim 2 or 3, wherein for several ultrasonic electrical transducers (4) respectively several ultrasonic radiating elements (7, 10) a common intermediate element (6) is available.

5. Ultrasonic device defined in claim 1, wherein the ultrasonic transducer is a piezo element (4).

6. Ultrasonic device defined in claim 2, wherein the ultrasonic emitting elements are probes (7) immersing into a sample liquid.

7. Ultrasonic device defined in claim 2, wherein the wave-transferring intermediate elements (5, 6) are preferentially made of aluminum or aluminum alloys and the radiating elements (7) preferentially made of aluminum or aluminum alloys with quartz tips tips.

8. Ultrasonic device defined in claim 3, wherein the ultrasonic radiating element is a metal plate (10).

9. Ultrasonic device defined in claim 1, wherein the sample volume (2) is contained in a sample container in a microplate (1), or in containers of similar arrangement, which can correspond also to parts of a microplate.

10. Use of an ultrasonic device according to claim 1 to 9 for disintegration of biological material for the sample preparation of PCR, genomics and proteomics, for sample preparation in enzymatic tests, hybridization- and receptor binding studies, for the acceleration, catalysis and increase of the yield of chemical reactions, for generating liposoms, micro emulsions or nanopaticles, as well as for suspending, homogenizing, emulsifying and extracting.
